(19) United States
(12) Patent Application Publication
(10) Pub. No.: US 2019/0230445 A1
(43) Pub. Date: Jul. 25, 2019

(54) SPEAKER

(71) Applicant: AAC Technologies Pte. Ltd., Singapore city (SG)

(72) Inventors: Peng Qin, Shenzhen (CN); Yuanxiang Mao, Shenzhen (CN)

(21) Appl. No.: 16/233,550

(22) Filed: Dec. 27, 2018

(30) Foreign Application Priority Data
Jan. 24, 2018 (CN) 201820123555.9

(51) Int. Cl. H04R 9/06; H04R 9/02; H04R 1/02; H04R 7/02

(52) U.S. Cl. CPC H04R 9/06; H04R 9/025; H04R 2307/023; H04R 7/02; H04R 2400/11; H04R 1/02

(57) ABSTRACT

The present disclosure provides a speaker. The speaker includes a frame, a vibrating diaphragm held in the frame, and a voice coil located below the vibrating diaphragm and configured to drive the vibrating diaphragm to vibrate to produce a sound. The speaker further includes a heat insulation material layer sandwiched at a junction between the vibrating diaphragm and the voice coil. According to the speaker in the present disclosure, the heat insulation material layer is additionally disposed between the vibrating diaphragm and the voice coil. The heat insulation material layer can prevent or reduce heat transferred by the voice coil to the vibrating diaphragm when the voice coil works, thereby reducing creeping of the vibrating diaphragm caused by heat and reducing a change in F₀. This increases a frequency response and improves acoustic performance of the speaker.

### CROSS-REFERENCE TO RELATED APPLICATIONS

This application claims the priority benefit of Chinese Patent Applications Ser. No. 201820123555.9 filed on Jan. 24, 2018, the entire content of which is incorporated herein by reference.

### TECHNICAL FIELD

The present disclosure relates to the field of electroacoustic transduction, and in particular, to a speaker.

### BACKGROUND

Acoustic devices are widely applied to portable electronic devices such as mobile phones and notebook computers. With rapid development of the portable electronic devices, people have higher functional requirements on the portable electronic devices, and the acoustic devices applied thereto also rapidly develop correspondingly. Currently, the acoustic devices have been developed toward miniaturization and have good acoustic performance.

Currently, in the acoustic devices, especially a speaker, problems exist that a large signal and a small signal based on F₀ are inconsistent, an F₀ offset is relatively large during several continuous tests, F₀ changes excessively greatly during the tests at different voltages, and so on. It is found through researches that, the speaker generates heat during working, a vibrating diaphragm creeps upon heat, and some rigidness is converted into stiffness, increasing Cₘₛ. Consequently, the speaker is heated and F₀ is reduced (Specifically, it can be learned from related tests that, for the speaker, F₀ changes from 970 Hz to 910 Hz as a low-frequency time increases; and as a low-frequency signal time increases, the speaker generates more heat, and F₀ is gradually reduced). In addition, it can be learned by analyzing an equivalent circuit in the following formula that

$${f}_{z} = \frac{1}{2 π \sqrt{{C}_{mes} {L}_{ces}}} ,$$

where Cₘₑₛ=Mₘₛ/B²1², L_{ces}=Cₘₛ·B²·1², and if Cₘₛ is increased, F₀ is reduced. For the foregoing problems, it is necessary to provide a speaker having a new structure.

### BRIEF DESCRIPTION OF THE DRAWINGS

FIG. 1 is a schematic exploded view of a three-dimensional structure of a speaker according to the present disclosure;

FIG. 2 is a schematic plan view of the speaker from another perspective according to the present disclosure; and

FIG. 3 is a schematic diagram of a cross section along a line A-A in FIG. 2.

### DETAILED DESCRIPTION

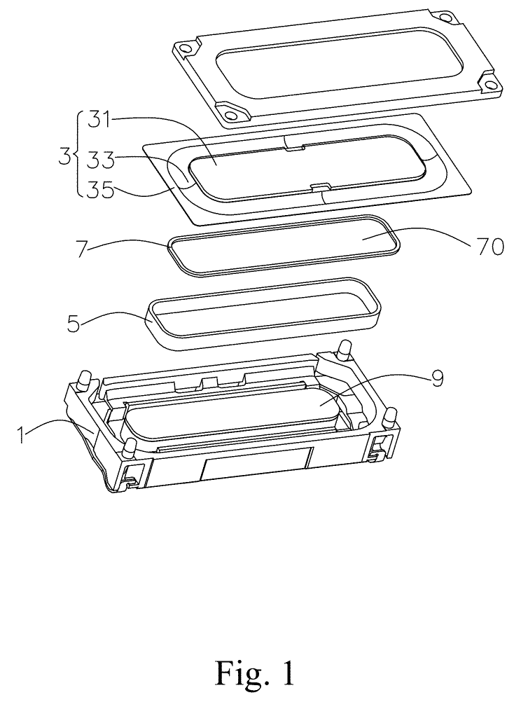

The following further describes the present disclosure in detail by using specific implementations with reference to FIG. 1 to FIG. 3, to better understand the schemes of the present disclosure and advantages in various aspects of the present disclosure. In the following embodiments, the following specific implementations are provided to facilitate clear and thorough understanding of content of the present disclosure, rather than limit the present disclosure. Terms such as above, below, left, and right indicating directions are merely used for positions of a shown structure in a corresponding accompanying drawing.

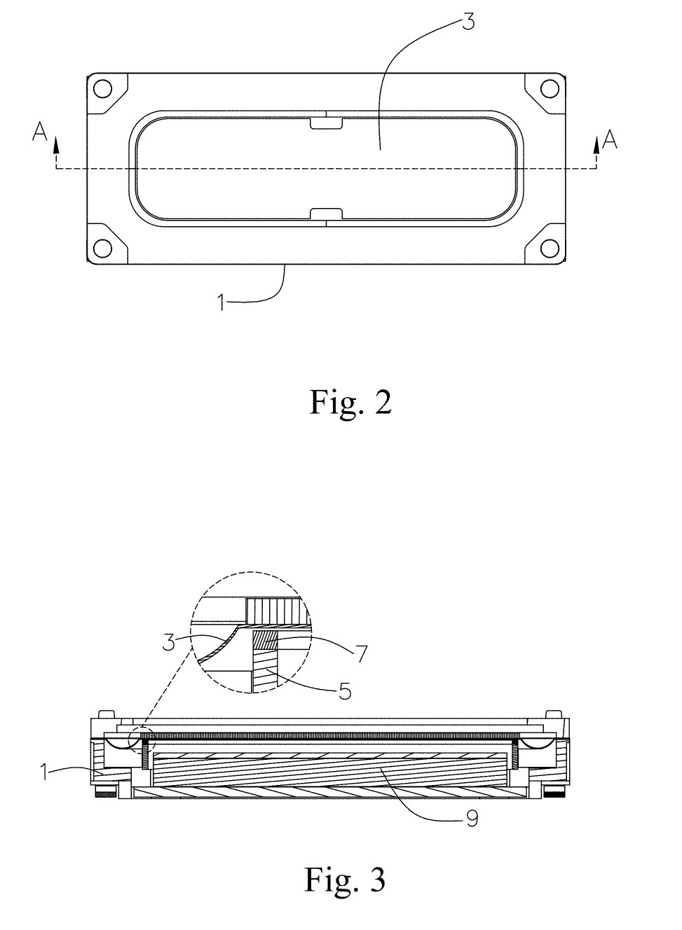

As shown in FIG. 1 and FIG. 2, the present disclosure provides a speaker. The speaker includes a frame 1, a vibrating diaphragm 3 held in the frame 1, a voice coil 5 located below the vibrating diaphragm 3 and configured to drive the vibrating diaphragm 3 to vibrate to produce a sound, and a heat insulation material layer 7 sandwiched between the vibrating diaphragm 3 and the voice coil 5. The speaker further includes a magnetic circuit system 9 accommodated in the frame 1, and the magnetic circuit system 9 forms a magnet gap for accommodating the voice coil 5.

For the problems that the speaker generates heat and the vibrating diaphragm creeps upon heat, causing the speaker to be heated and a resonance frequency F₀ to be reduced, according to the speaker in the present disclosure, the heat insulation material layer 7 is additionally disposed between the vibrating diaphragm 3 and the voice coil 5, that is, at a junction between the vibrating diaphragm 3 and the voice coil 5. In this implementation, a material of the heat insulation material layer 7 is preferably ceramics or graphene. In addition, the material of the heat insulation material layer 7 may alternatively be another material having good heat insulation performance, being light, and having a small density. For details, refer to FIG. 1 and FIG. 3.

In this implementation, a shape of the heat insulation material layer 7 is a rectangular ring shown in FIG. 1, and corresponds to a shape of the voice coil 5. In addition, the heat insulation material layer 7 may be of a rectangle, a polygon, or another shape having a through hole 70. An outline of the heat insulation material layer 7 overlaps an outline of the voice coil 5, or an outline of the heat insulation material layer 7 is located further outward than an outline of the voice coil 5.

The heat insulation material layer 7 can prevent or reduce heat transferred by the voice coil 5 to the vibrating diaphragm 3 when the voice coil 5 works, thereby reducing creeping of the vibrating diaphragm 3 caused by heat and reducing a change in F₀. In addition, the heat insulation material layer 7 further avoid a problem that the voice coil 5 has a difficulty in entering magnet gap at the junction between the voice coil 5 and the vibrating diaphragm 3, increasing a frequency response.

In addition, the vibrating diaphragm 3 includes a dome portion 31, an edge portion 33 surrounding the dome portion 31, and a fixing portion 35 extending from the edge portion 33. The edge portion 33 includes a protrusion and is of a hollow structure. The fixing portion 35 is configured to fixedly couple to the frame 1. The vibrating diaphragm 3 is configured to vibrate to produce a sound. Specifically, the vibrating diaphragm 3 produces a sound through vibration under the drive of the voice coil 5, to convert an audio drive signal into a sound, thereby implementing electroacoustic conversion. For details, refer to FIG. 1.

Compared with the prior art, the heat insulation material layer is additionally disposed between the vibrating diaphragm and the voice coil. The heat insulation material layer can prevent or reduce heat transferred by the voice coil to the vibrating diaphragm when the voice coil works, thereby reducing creeping of the vibrating diaphragm caused by heat and reducing a change in F₀. This increases a frequency response and improves acoustic performance of an acoustic device.

The above descriptions are merely implementations of the present disclosure. It should be noted herein that a person of ordinary skill in the art may make improvements without departing from the creative ideas of the present disclosure, and all these improvements shall fall within the protection scope of the present disclosure.

What is claimed is:

1. A speaker, wherein the speaker comprises a frame, a vibrating diaphragm held in the frame, and a voice coil located below the vibrating diaphragm and configured to drive the vibrating diaphragm to vibrate to produce a sound, wherein the speaker further comprises a heat insulation material layer sandwiched at a junction between the vibrating diaphragm and the voice coil.

2. The speaker according to claim 1, wherein the heat insulation material layer is ceramics or graphene.

3. The speaker according to claim 1, wherein the heat insulation material layer is a rectangle or polygon having a through hole.

4. The speaker according to claim 1, wherein an outline of the heat insulation material layer overlaps an outline of the voice coil.

5. The speaker according to claim 1, wherein an outline of the heat insulation material layer is located further outward than an outline of the voice coil.

6. The speaker according to claim 1, wherein the speaker further comprises a magnetic circuit system accommodated in the frame, and the magnetic circuit system forms a magnet gap for accommodating the voice coil.
